(19) United States
(12) Patent Application Publication
(10) Pub. No.: US 2010/0228834 A1
(43) Pub. Date: Sep. 9, 2010

(54) METHODS, SYSTEM AND COMPUTER PROGRAM PRODUCT FOR DELIVERING WELL DATA

(75) Inventors: Nicholas HUNG, The Woodlands, TX (US); Mike E. ROSENMAYER, Houston, TX (US); James S. CULBERTSON, Driftwood, TX (US); Fredrik SJODIN, Richmond, TX (US)

Correspondence Address: CANTOR COLBURN LLP- BAKER HUGHES INCORPORATED, 20 Church Street, 22nd Floor, Hartford, CT, 06103, US

(73) Assignee: BAKER HUGHES INCORPORATED, Houston, TX (US)

(21) Appl. No.: 12/715,559

(22) Filed: Mar. 2, 2010

Related U.S. Application Data
(60) Provisional application No. 61/157,454, filed on Mar. 4, 2009.

(51) Int. Cl. G06F 15/173; G06F 15/16

(52) U.S. Cl. 709/217; 709/224

(57) ABSTRACT

A method of delivering well data is disclosed. The method includes: monitoring a host well data system by a client computer; the host well data system including at least one storage component configured to store well data therein; and determining, without requiring user interaction, whether the well data includes new well data, which includes data that has not been previously delivered to a user.

### CROSS REFERENCE TO RELATED APPLICATIONS

This application claims the benefit of an earlier filing date from U.S. Provisional Application Ser. No. 61/157,454 filed Mar. 4, 2009, the entire disclosure of which is incorporated herein by reference.

### BACKGROUND OF THE INVENTION

During hydrocarbon drilling, exploration and recovery operations, various properties of earth formations, boreholes and/or downhole components are measured, typically by lowering measurement tools into a drilled borehole. Data representing such properties is important for many aspects of energy industry operations, such as evaluating the constituents and characteristics of an earth formation, monitoring petroleum production and monitoring downhole component operation.

Data resulting from measurements is generally stored in various databases for access by users. Access to measurement data is typically accomplished by logging into a database and requesting delivery of data via, for example, e-mail messages and/or websites. Delivery via e-mail can be unreliable, as actual delivery of the data, much less timeliness, is not guaranteed. In addition, e-mail client software varies, which makes guiding customers to their data more difficult. Access via web browsers may also introduce problems, such as difficulty in navigating a web site, and is subject to other problems, including pop-up blockers and over-strict security settings. All of these data-access methods require the user to interact with the data delivery mechanism.

### BRIEF SUMMARY OF THE INVENTION

A method of delivering well data includes: monitoring a host well data system by a client computer, the host well data system including at least one storage component configured to store well data therein; and determining, without user interaction, whether the well data includes new well data including data that has not been previously delivered to a user.

A method of delivering well data includes: monitoring a host well data system by a client computer, the host well data system including at least one storage component configured to store well data therein; determining, without requiring user interaction, whether the well data includes new well data including data that has not been previously delivered to a user; receiving, without requiring user interaction, at least one subset of the new well data, the subset including data conforming to at least one type of data that the user has previously selected for delivery; and delivering the at least one subset of the new well data.

A computer program product is disclosed that includes machine-readable instructions stored on machine-readable media. The instructions are for delivering well data by implementing a method including: monitoring a host well data system, which includes at least one storage component configured to store well data therein, by a client computer; and determining without user interaction whether the well data includes new well data including data that has not been previously delivered to a user.

A system for delivering well data includes a host well data system including at least one storage component configured to store well data therein, and a client computer communicatively coupled to the host well data system. The client computer performs: monitoring the host well data system without user interaction; and determining, without user interaction, whether the well data includes new well data including data that has not been previously delivered to a user.

### BRIEF DESCRIPTION OF THE DRAWINGS

The following descriptions should not be considered limiting in any way. With reference to the accompanying drawings, like elements are numbered alike:

FIG. 1 depicts an embodiment of a well logging, production and/or drilling system;

FIG. 2 depicts an embodiment of a data processing and delivery system;

FIG. 3 depicts an architecture of a host system of the data processing and delivery system of FIG. 2;

FIG. 4 depicts an architecture of a client system of the data processing and delivery system of FIG. 2;

FIG. 5 is a flow chart providing an exemplary method of delivering well data to a user;

FIG. 6 is an entity relation diagram (ERD) of an exemplary data model;

FIG. 7 depicts an embodiment of an interface display of the client system of FIG. 4;

FIG. 8 depicts an embodiment of “Login” dialog box of the interface display of FIG. 7;

FIG. 9 depicts an embodiment of a “View Downloads” or “Download Activity” dialog box of the interface display of FIG. 7;

FIG. 10 depicts an embodiment of a “What's New” tab of the interface display of FIG. 7;

FIG. 11 depicts an embodiment of a “Local Wells” tab of the interface display of FIG. 7;

FIG. 12 depicts an embodiment of a “Local Zips” tab of the interface display of FIG. 7;

FIG. 13 depicts an embodiment of the General Settings tab of the “Change Settings” dialog box of the interface display of FIG. 7;

FIG. 14 depicts an embodiment of the Download Settings tab of the “Change Settings” dialog box of the interface display of FIG. 7;

FIG. 15 depicts an article of manufacture or a computer program product for executing the method of FIG. 5.

### DETAILED DESCRIPTION OF THE INVENTION

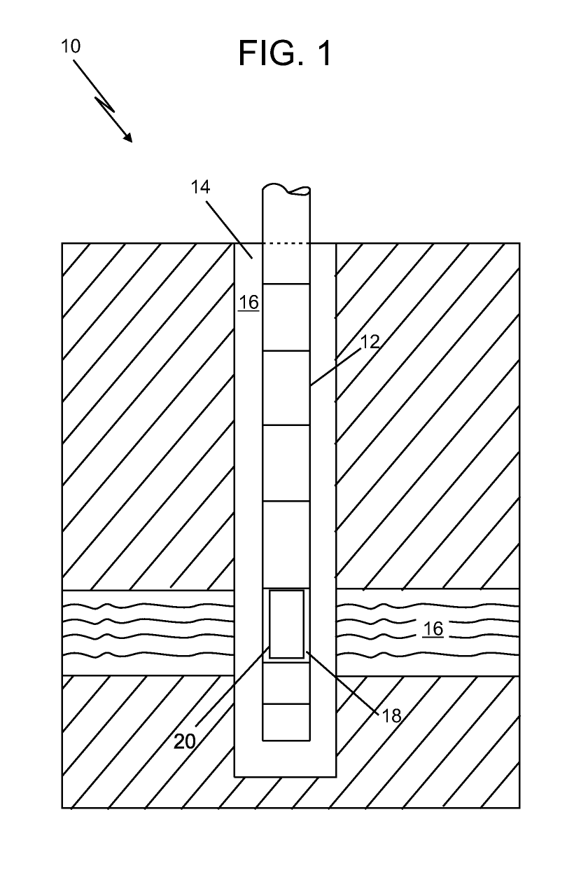

Referring to FIG. 1, an exemplary embodiment of a well logging, production and/or drilling system 10 includes a toolstring 12 that is shown disposed in a borehole 14 that penetrates at least one earth formation 16 during a drilling, well logging and/or hydrocarbon production operation. In one embodiment, the string 12 includes a drill pipe, which may be one or more pipe sections or coiled tubing. In one embodiment, the system 10 also includes a bottomhole assembly (BHA) 18. The BHA 18, or other portion of the borehole string 11, includes a measurement assembly 20 configured to estimate at least one property of the formation 14 and/or the borehole 12, and optionally to store and/or transmit data relating to at least one property. The BHA 18 and/or the measurement assembly 20 incorporates any of various transmission media and connections, such as wired connections, fiber optic connections, wireless connections, and mud pulse telemetry.

“Drillstring,” “toolstring,” or “string”, as used herein, refers to any structure or carrier suitable for lowering a tool through a borehole or connecting a drill bit to the surface and is not limited to the structure and configuration described herein. The term “carrier” as used herein means any device, device component, combination of devices, media and/or member that may be used to convey, house, support or otherwise facilitate the use of another device, device component, combination of devices, media and/or member. Exemplary non-limiting carriers include drill strings of the coiled tube type, of the jointed pipe type and any combination or portion thereof. Other carrier examples include casing pipes, wirelines, wireline sondes, slickline sondes, drop shots, downhole subs, BHA's, drill string.

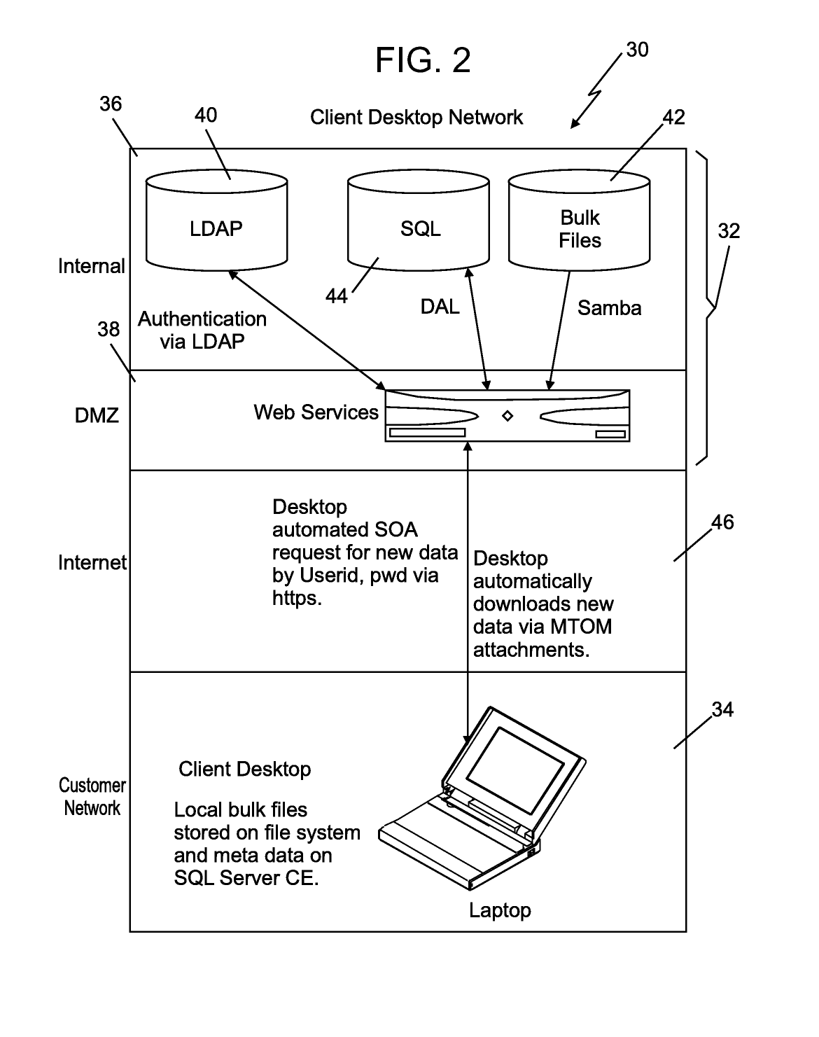

Referring to FIGS. 2-4, an embodiment of a data processing and delivery system 30 is shown. The system 30 includes a host system 32 and a client system 34 such as a client desktop personal computer 34. The systems 32, 34 are not limited to the configurations described herein, and may include any suitable device or network including various processors, memory and communications devices.

The host system 32 includes a data subsystem 36 and a communication subsystem 38. The data subsystem 36 includes various databases and control units to allow interaction between the databases and the client system 34. For example, the data subsystem 36 includes an authentication database 40 such as a lightweight directory access protocol (LDAP) server. The data subsystem 36 may also include a bulk data files database 42 in communication with a bulk data control unit utilizing a suitable communication protocol such as Samba, and an energy industry database 44 in communication with an energy industry database control unit. In one embodiment, the energy industry database 44 is a structured query language (SQL) database.

The energy industry database 44, also referred to as a well database, includes data resulting from various measurements taken of formation and/or borehole properties, as well as measurements relating to downhole or surface components of various well logging, production and/or drilling devices and systems. Examples of such measurements include formation and/or fluid sample measurements, formation evaluation measurements such as resistivity and nuclear magnetic resonance (NMR) measurements, and drilling or production measurements such as fluid temperature and fluid flow rates. The data utilized in the systems, devices and methods described herein may be generally referred to as “well data”, and is not limited to the specific data types described herein. Well data may include any data of interest in energy industry operations.

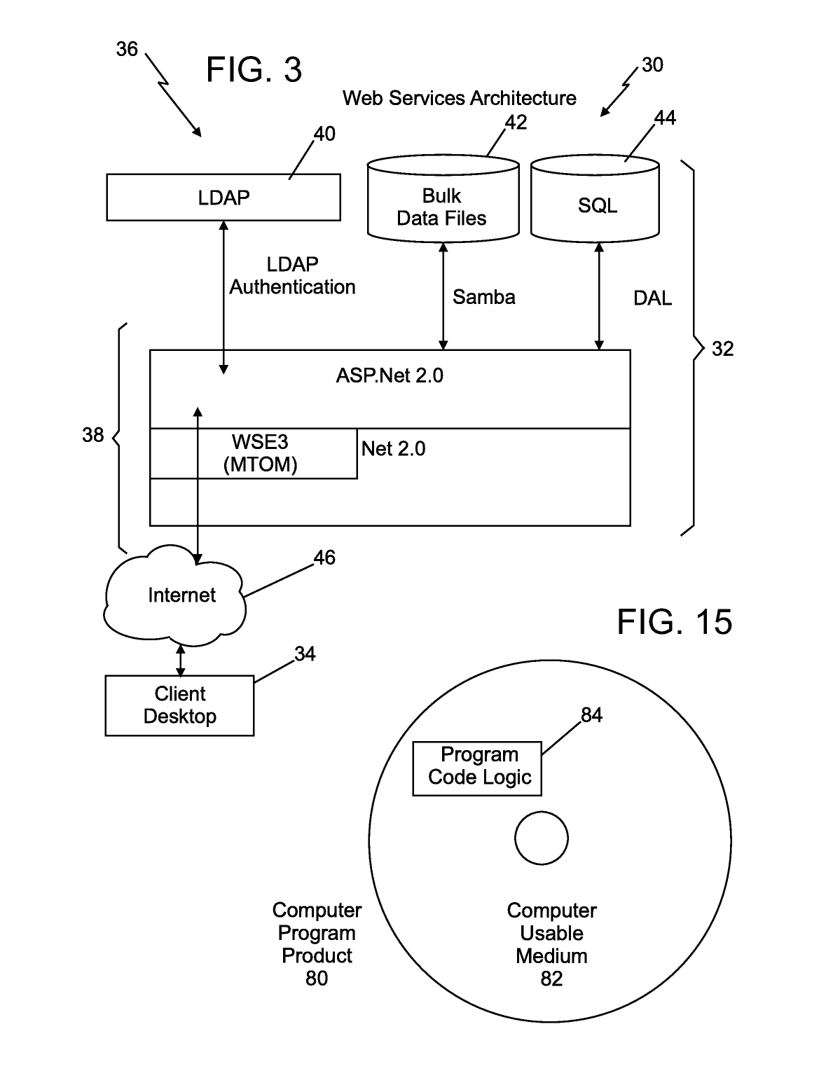

In one embodiment, the communication subsystem 38 allows the client system 34 to request new well data and then download the data files associated with the data via, for example, a network such as the Internet 46. Any or all network and Internet communication may be encrypted within a secure communications protocol, such as the Secure Hypertext Transmission Protocol Secure (HTTPS). In one embodiment, the communication subsystem 38 is configured as a “demilitarized zone” or “demarcation zone” (DMZ) that contains the host system's external services to the Internet 46 or other network. In one embodiment, as shown in FIG. 3, an application which implements an electronic communication protocol such as message transmission optimization mechanism (MTOM) is utilized to allow the buffered delivery of file downloads (and eventually uploads) via the communication subsystem 38. The communication subsystem 38 is also referred to as a “web services” subsystem 38 for the instance where communication between the host and client systems is via the Internet 46.

The client system 34, in one embodiment, includes a computer having one or more programs or software such as a Client Desktop Application (CDA), to facilitate requests for data and receipt of data from the data subsystem 32. The client system includes computing hardware and software protocols that constantly, periodically, or from time to time monitor the host system 32 and that receive and store appropriate new well data from the host system 32. Appropriate new well data includes data that fits selected criteria, including data that the user is entitled to and data of a type that the user has previously selected or otherwise previously indicated is desired. The client system 34 may also perform such functions as remembering a user's password, notifying a user of new data and facilitating opening the associated data file(s).

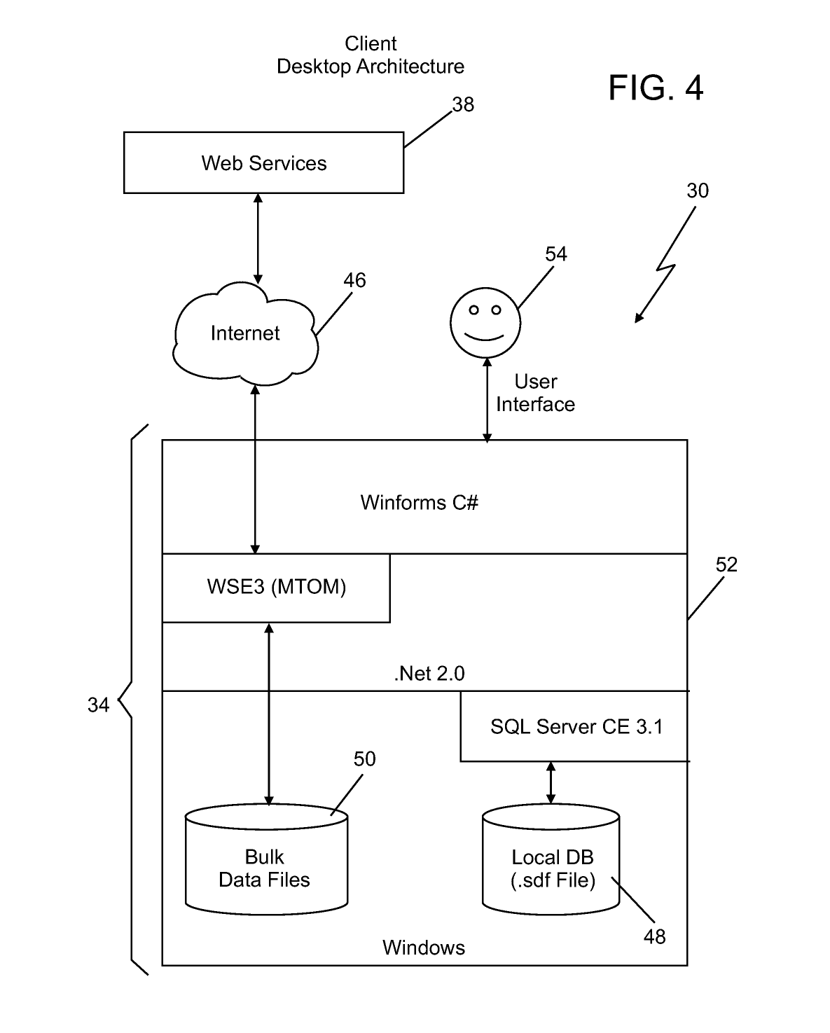

As shown in FIG. 4, an exemplary client system 34 includes one or more data storage components such as a local database 48 for storage of well data and a bulk data files database 50 for storage of bulk data files. In one embodiment, such bulk data files include compressed data files such as file in a ZIP format, referred to herein as “Zip files” or “Zips”. In one example, the local database 48 is a relational database such as the Microsoft SQL Server Compact (SQL CE). The client system 34 also includes a client communication subsystem 52 including, for example, an application which implements a protocol such as MTOM to facilitate communication and data transfer between the client system 34 and exterior locations such as through the Internet 46 and/or to the host system 32. A user interface 54 includes, for example, a suitable graphical user interface (GUI).

In one embodiment, the local bulk data files are stored in the bulk data files database 50 using a filesystem-based hierarchy. An example of such a file hierarchy is a <DataRoot>\<Operating Company>\<Field>\<Wellbore> hierarchy. In one embodiment, the default DataRoot directory is a directory stored at a location in the client system, such as in the “My Documents” folder in the client system's persistent storage.

Various metadata is stored in the local database 48 that is associated with received well data. Metadata may be stored in a separate filesystem-based database hidden in the user's Application Data directory, and may follow the same naming convention as the well data database 44.

Metadata can be stored in any suitable manner. For example, the metadata may be stored as a text file, which can be stored by mapping metadata stored in Extensible Markup Language (XML) files or in a flat text file to a well datafile.

Examples of Metadata are shown below. Although the Metadata described herein is shown in conjunction with a web services database, the metadata may be used in conjunction with any well data storage location or database. Metadata examples include:

From the host system 32:

Message ID

Message Version

Data Distributor (e.g., Baker Hughes, Inc.)

Uploading Company

Uploader Username

Uploader Comment-to-Customer

Operating Company

Project

Field

Well

Wellbore

Wellbore universally unique identifier (UUID)

API/Well ID

Local Filename

Local File Path

Original Filename

Folder

File UUID

From the client system 34:

Client Program Name/Designation

Client Version Number (at time of upload)

File Path on Local PC

File Status (e.g. Downloaded, Downloading, Queued-for-Download, Error, Revoked, Updated, User-Removed)

File Status Detail (e.g. Error Message, Updated File's New UUID, etc. This is a supplement to the File Status field.)

Date & Time Received

Hostname of Recipient PC

Username of Data Downloader

Comments or Description by the Customer (sent to CDA as a supplement to LQA. Customers may submit more than one comment, which are listed sequentially)

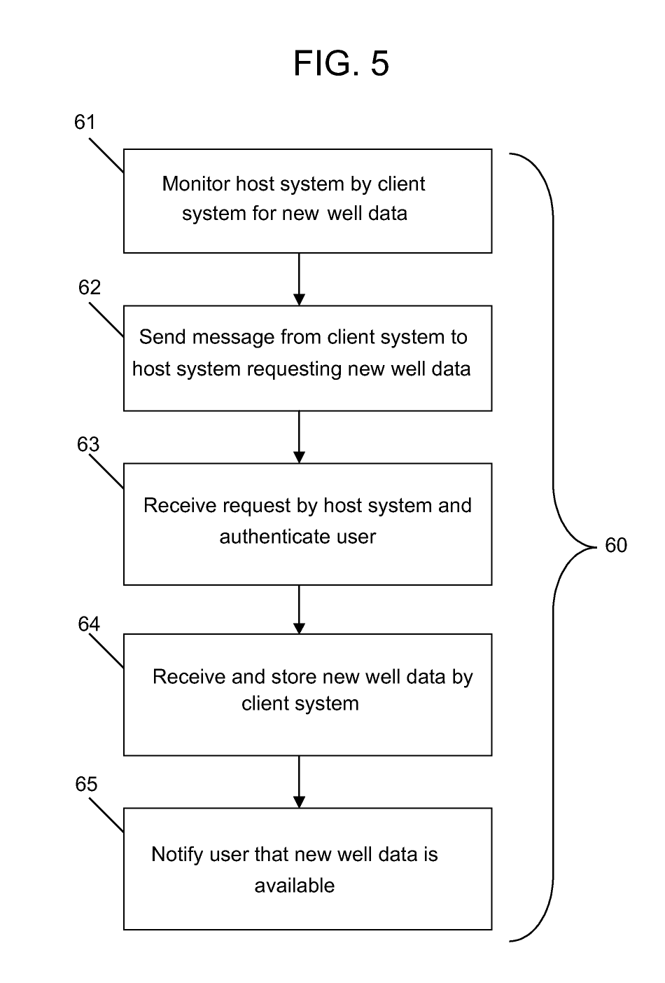

FIG. 5 illustrates a method 60 of querying for and/or delivering well data to a user. The method 60 is used in conjunction with the host system 32 and the client system 34, although the method 60 may be utilized in conjunction with any suitable combination of processors and networks. The method 60 includes one or more stages 61, 62, 63, 64 and 65. In one embodiment, the method 60 includes the execution of all of stages 61-65 in the order described. However, certain stages may be omitted, stages may be added, or the order of the stages changed.

In the first stage 61, the client system 34 continuously or periodically monitors the host system 32 and determines whether new well data is available. In one embodiment, the client system 34 is configured to allow a user to log into the client system 34 and enter preferences for the types of data desired. Such data types include data classified based on measurement types, specific wellbores and specific wellbore fields. The client system 34 monitors the host system 32 to determine whether new well data (i.e., data that has not been downloaded to the client system 34) is stored in the host system 32 that conforms to the user's preferences.

In the second stage 62, the client system 34 sends a message requesting the new well data from the host system 32. In one embodiment, the host system 32 assumes that requests will come from one computer, although the client system may be allocated additional computers or user stations on, for example, a case-by-case basis.

In the third stage 63, the host system 32 receives the request, and also receives appropriate additional information, such as the user identifier (ID) and password. In one embodiment, the host system 32 authenticates the user by determining whether the user is valid and has entered the correct password, such as by referencing the authentication database 40. The hosts system also determines whether the user is entitled to the requested data.

In the fourth stage 64, the client system 34 receives the requested new well data if the user is determined to be valid and entitled to the well data. The client system 34 stores the requested new well data in a storage location such as the local database 48. Data Delivery can be achieved, for example, via a Push-from-Server or a Pull-to-Client Model. The client system 34 may organize the well data on the client system 34 for convenient access by the user.

In the fifth stage 65, the client system 34 notifies the user that new well data is available for access by the user. Such notification may be in any suitable form, such as an audible notification, a text notification, or a graphical notification such as an icon or image.

The following examples, including a number of “Use Cases”, illustrate various uses of the data processing system 30 and associated processing flows. In these examples, energy industry subsystem 36 includes a database, which is a structured query language (SQL) server that stores various types of well data. In these examples, the communication subsystem 38 utilizes various web services, referred to as web services (WS). The authentication database 40 is a Lightweight Directory Access Protocol (LDAP) server. The client system 34 includes a computer having a processor that executes the Client Desktop Application (CDA).

### Use Case 1—Client Desktop Application Logs Into Web Services

In this example, a user initiates a session by entering identification (UserId) and a password into CDA, or the UserId and/or password is stored from previous entry. In this example, an identifier such as a globally unique identifier (Guid) is assigned to the specific CDA. The processing flow is as follows:
1. CDA creates an object (e.g., “CookieContainer” object) to store the session information;
2. CDA retreives the Guid for the ComputerId from its local persistent storage, such as from a hard drive. In the instance that the ComputerId is not available, CDA generates a Guid for the computer and saves it to the local persistent storage;
3. CDA sends an encrypted authentication request to WS with the UserId, the password that the user has previously entered into the CDA, and the Guid (ComputerId) of the computer for the CDA application;
4. WS receives the request and sends an authentication request to the LDAP server (via an internal network) with the UserId and Password (WS may set a timeout period for response);
5. LDAP responds to WS indicating the user is validated;
6. WS creates a session for the given UserId to persist the authentication;
7. WS responds to CDA that the Authentication Result indicating that the user is validated, e.g., an Authentication code is returned to CDA.

In the instance that the authentication fails, LDAP responds in step 5 to WS with an Authentication Result indicating that the login has failed (e.g., code -1 through -8), see meaning of codes below, and WS responds to CDA that the Authentication Result indicates that the login has failed.

In the instance that LDAP is unavailable, LDAP does not respond to WS within the timeout period. WS responds to CDA that the Authentication Result indicating that LDAP is unavailable (e.g., code 0).

In the instance that the ComputerId is Not Accepted, WS responds to CDA that the Authentication Result indicates that the ComputerId is not accepted for the UserId.

Exemplary authentication codes include: “1” if authentication is successful, “-1” if user password fails, “-2” if user is inactive, “-3” if UserId does not exist, “-4” if login attempts exceeded a threshold amount, “-5” if Userid or Password or SystemName is empty, “-6” if Unknown message from LDAP, “-7” if ComputerId is not accepted, “-8” if UserId is a non-client user, and “0” if LDAP is unavailable.

The following table shows a schema including the various fields and associated values used by the server and the client. The schema can be shared on both the server and the client so that the typed dataset can be merged with the client dataset when returned.

Input

| Parameter | Type | |
|---|---|---|
| UserId | String | The UserId of the person requesting |
| | | authentication |
| Password | String | The password provided by the user |
| ComputerId | Guid | The Guid Computer ID of the client computer. |

Output

| Parameter | Type | |
|---|---|---|
| AuthenticationResult | Int | 1 if authentication is successful |
| | | −1 if user password fails |
| | | −2 if user is inactive |
| | | −3 if user is user id does not exist |
| | | −4 if login attempts exceed |
| | | −5 if UserId or Password or |
| | | SystemName is empty |
| | | −6 if Unknown message from LDAP |
| | | −7 ComputerId not accepted for the |
| | | user. |
| | | 0 if LDAP is not available. |
| PasswordDaysRemaining | Int Out | Number of days remaining before |
| | | password expires, −1 if password is |
| | | already expired. |

### Use Case 2—Client Desktop Application Requests New Well Data

If the user has been authenticated and is in session on WS, the processing flow is as follows:
1. CDA sends an optionally encrypted new data request (GetNewWellData(UserId) Request) to WS with UserId of the user, their preferred folder groups for their preference, their preferred data types, and whether they want to retrieve files previously downloaded via the website.
2. WS receives request and checks that UserId is authenticated in session.
3. WS uses the database access layer (DAL) to return a strongly-typed dataset that contains metadata about wells and well data files that are entitled to the user. In one embodiment, the well data files must meet certain criteria such as: the data files are not older than a period of time (e.g., seven days) since creation, are not classified as “archived,” have not been previously downloaded by that UserId from the web service, have not been downloaded by that UserId via the website (if that switch is set), are within the preferred data types, and are within the folders indicated by the preferred folder groups (excludes internal use folders and trash). The expansion of the folder groups and data types may be performed on the DAL, based on a LookupTable. On the server side, “new data” is defined as data files received in the last seven days (by create date) or other selected period of time, entitled to the UserId, not classified as archive, and within the preferred folder and data types. The preferredFolderGroups and preferredDataTypeGroups may be expanded on the server side to actual folders and data types via the lookup table. The preferredFolderGoups will exclude internal use folders and trash.
4. CDA checks that the dataset contains at least one data file and saves the data to the local database structure. The initial value for the data file is set to “Queued for download”, for example.

In the instance that the UserId Session Does Not Exist, WS responds in step 3 that the session does not exist (e.g., Session=0). CDA restarts flow with the login request outlined in Use Case 1. A bad session may throw a Custom Simple Object Access Protocol (SOAP) Exception.

In the instance that the database contains no new data files, CDA checks that the collection contains no new data files and exits the data update thread.

The following table shows a schema including the various fields and associated values used by the server and the client.

Input

| Parameter | Type | |
|---|---|---|
| userId | String | The User Id (431) of the |
| | | person requesting |
| | | authentication |
| preferredFolderGroups | String[ ] | Array of strings with the |
| | | preferred folder groups. |
| preferredDataTypeGroups | String[ ] | Array of strings with the |
| | | preferred data types. |
| excludePreviousWebDownloads | boolean | Switch to determine |
| | | whether to download files |
| | | that have been previously |
| | | downloaded from the |
| | | website for that user. |
| | | Previously downloaded |
| | | files from the web service |
| | | are automatically excluded. |

Output

| Parameter | Type | |
|---|---|---|
| DataFilesDataSet | Typed DataSet | Typed dataset of the projects that |
| | | contain new data, containing |
| | | Project, Well, Wellbore, Folder, |
| | | and DataFile tables. |

### Use Case 3—Client Desktop Application Requests New Condensed (Zip) Data

If the user has been authenticated and is in session on WS, the processing flow is as follows:
1. CDA sends GetNewZipData( )Request to WS (via https) with UserId of the user.
2. WS receives request and checks that UserId is authenticated in session.
3. WS uses the DAL to return a strongly-typed dataset that contains meta data about zip data files that are in the user's download area and not older than, for example, seven days since creation.
4. CDA checks that the dataset contains at least one data file and saves the data to the local database structure. The initial value for the data file is set to “Queued for download”. The dataset with zip data file meta-data is returned and saved to CDA.

In the instance that the UserId Session Does Not Exist, WS receives the request and responds that the session does not exist (Session=0). CDA restarts flow with the login request outlined in Use Case 1. A bad session may throw a Custom SOAP Exception.

In the instance that the data collection contains no new data files, CDA checks that the collection contains no new data files and exits the data update thread. On the server side “new zip data” is defined as data files within the user's download area and not older than seven days.

The following table shows a schema including the various fields and associated values used by the server and the client.

Input

| Parameter | Type | |
|---|---|---|
| UserId | String | The User Id (431) of the person |
| | | requesting authentication |

Output

| Parameter | Type | |
|---|---|---|
| ZipDataFilesSet | Typed DataSet | Typed dataset of the projects that |
| | | contain new data, containing |
| | | ZipDataFile tables. |

### Use Case 4—Client Desktop Downloads New Well Data

In this case, a well data file has been marked as “Queued for Download” in the CDA local database. The processing flow is as follows:
1. CDA updates the data file as “Downloading”.
2. CDA uses the MTOM library to download the particular file. This MTOM library can be used as a starting point for the client/web service interactions
3. CDA creates a new FileTransferDownload object from the MTOM library with the Guid well file ID as the constructor.
4. CDA sets the properties of the FileTransferDownload object with the UserId, the destination temporary folder, and a Guid to track the thread.
5. CDA queues a thread with the object and waits for callback from the WS.
6. WS receives request and checks that UserId is authenticated in session. WS verifies that the file is entitled to the user and stores that in session.
7. WS sends the chunk to CDA, and the MTOM library saves the file into a temporary folder.
8. CDA moves the file from the temporary to the target folder (File is downloaded to CDA).
9. CDA updates the data file as “Downloaded”.

In the instance that the UserId session does not exist, WS sends a SoapException message indicating that the session does not exist, and the CDA restarts flow with the login request outlined in Use Case 1. A bad session may throw a Custom SOAP Exception.

In the instance that the Data Files are not entitled to user, WS generates an exception that the data files is not entitled to the user.

The following table shows a schema including the various fields and associated values used by the server and the client.

Input

| Parameter | Type | |
|---|---|---|
| UserId | String | The User Id (431) of the person |
| | | requesting authentication |
| FilePath | String | The complete path to the file. |
| offset | Int64 | The transfer position within the file. |
| chunkSize | Int | The size of the chunk of data to grab. |

Output

| Parameter | Type | |
|---|---|---|
| Buffer | byte[ ] | Array of bytes returned by the chunk. |

This is one of several supporting methods for the download that is covered in the use cases. The FileTransferDownload object in the MTOM library may be used to interface to these methods rather than directly calling them directly.

### Use Case 5—Client Desktop Downloads New Zip File Data

If Zip data files have been marked as “Queued for Download” in the CDA local database, the process flow is as follows:
1) CDA updates the data file as “Downloading”.
2. CDA uses the MTOM library to download the particular file.
3. CDA creates a new FileTransferDownload object from the MTOM library with the integer zip file ID as the constructor.
4. CDA sets the properties of the FileTransferDownload object with the UserId, the destination temporary folder, and a Guid to track the thread.
5. CDA queues a thread with the object and waits for callback.
6. WS receives request and checks that UserId is authenticated in session. WS send chunks to CDA, and the MTOM library saves the file into the temporary folder. The file is downloaded to CDA.
7. CDA moves the file from the temporary to the target folder.
8. CDA updates the data file as “Downloaded”.

In the instance that the UserId Session Does Not Exist, WS throws a SoapException indicating that the session does not exist, and CDA restarts flow with the login request outlined in Use Case 1.

### Use Case 6—Client Desktop Confirms Save of New Data

If new well data files and/or zip data files have been saved to the CDA database, the following process flow is used to mark the data as downloaded for the UserId and computerId for the data files:
1. CDA queries for Well Data Files that are not recorded as “Confirmed as Saved”.
2. CDA sends ConfirmSavedNewData( )Request to WS (via https) with the UserId of the User and an array of well data file ID's and zip data file ID's (one of the arrays can be empty).
3. WS receives request and checks that UserId is authenticated in session and gets the ComputerId from the session.
4. WS records all of the data files in each array as downloaded by the UserId and ComputerId.
5. WS responds with a boolean true that processing was OK.
6. CDA records the Well Data Files and Zip Data Files (as applicable) as “Confirmed as Saved.”

In the instance that the UserId Session Does Not Exist, WS responds with a SoapException indicating that the Session does not exist, and CDA restarts flow with the login request outlined in Use Case 1.

In the instance that WS does not respond, CDA exits the flow and does not mark the data files as “Confirmed as Saved”.

The following table shows a schema including the various fields and associated values used by the server and the client.

Input

| Parameter | Type | |
|---|---|---|
| UserId | String | The User Id (431) of the person requesting |
| | | authentication |
| WellDataFileIds | Guid[ ] | Array of ID's for the well data files. |
| ZipDataFileIds | Int[ ] | Array of ID's for the zip files. |

Output

| Parameter | Type | |
|---|---|---|
| ProcessingOK | bool | Indicates “true” that processing was OK. |

Either of the WellDataFilelds or ZipDataFilelds can be an empty array, depending on whether there was any new data for that particular type. Both input arrays shouldn't be empty.

### Use Case 7—Client Desktop Checks for New Version

When the CDA begins execution, the process flow is as follows:
1. CDA sends CheckVersionNumber( )request to WS.
2. WS returns latest version number of the application.
3. CDA verifies that its current version is a match and starts normally.

If the CDA determines that its current version is less than the latest version number of the application, the CDA initiates its upgrade function. If there is no response from WS, CDA starts normally (could be offline and unable to check).

The following table shows a schema including the various fields and associated values used by the server and the client.

Input

| Parameter | Type |
|---|---|
| (none) | |

Output

| Parameter | Type | |
|---|---|---|
| LatestVersionNumber | string | Latest version of the CDA software. |

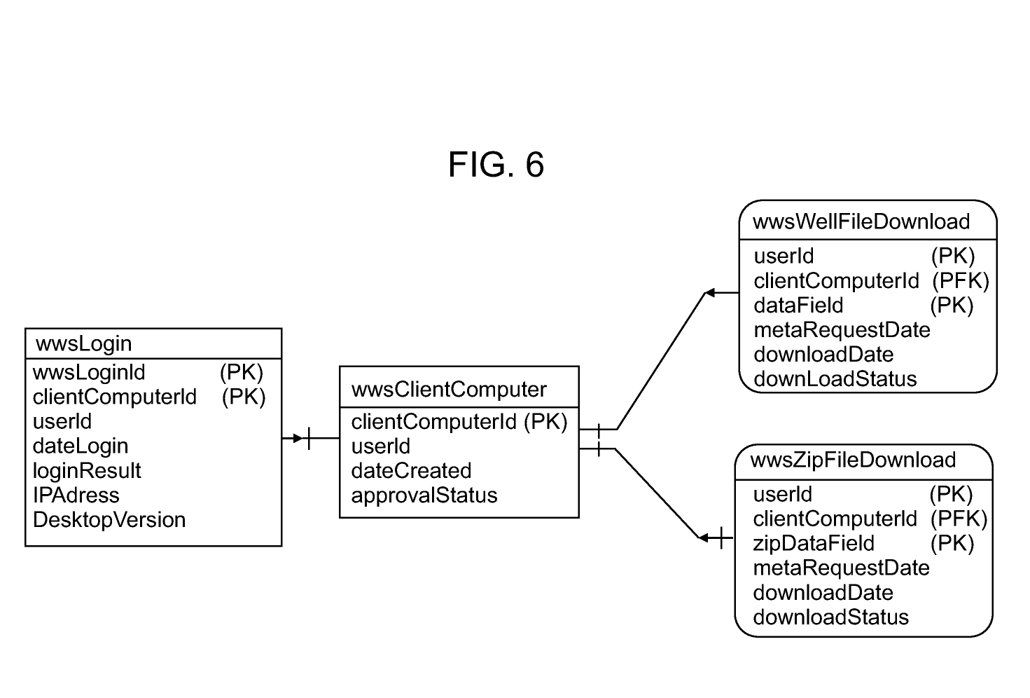

FIG. 6 is an entity relation diagram (ERD) of an exemplary data model associated with the examples described herein, where the host system 32 includes a server system. This model may be used to record results of the methods used by the system 30, including registration of the computers/users using Client Desktop, the logins, and the download of well data files and zip files. The ERD of the data model extensions shown in FIG. 5 are described below:

### ClientComputer

clientComputerId—Guid that is associated with the client app computer—generated by the Client App on startup and saved locally.
userId—userId associated with the computer
dateCreated—the date/time that the clientComputerId was first registered.
approvalStatus—The first ClientComputer is automatically approved. The second will be on a request basis and approved by the server admin.
macAddresses—Concatenated string of all of the MAC addresses on the computer, delimited by |(pipe).

### WellFileDownload

userId—userId associated with the file request.
clientComputerId—Guid associated with the client app computer.
DataFileID—Guid ID of the data file.
metaRequestDate—the date/time the meta data was requested
DownloadDate—the date/time that the download was actually completed.
   ZipFileDownload—Same as the previous except it is pointing to a different entity on the server, so the FileId is integer rather than Guid.
   Login—Stores information for each login and login attempt:
userId—userid of the account making the request.
clientComputerId—Guid that is associated with the client application computer (Client App)—generated by the Client App on startup and saved locally.
dateLogin—date/time of the login
loginResult—integer code of the login result, e.g. 1=successful.
IPAddress—the IP address of the originating request.
DesktopVersion—the version number of the Desktop app making the request. Can be used to flag users that are behind on upgrades.

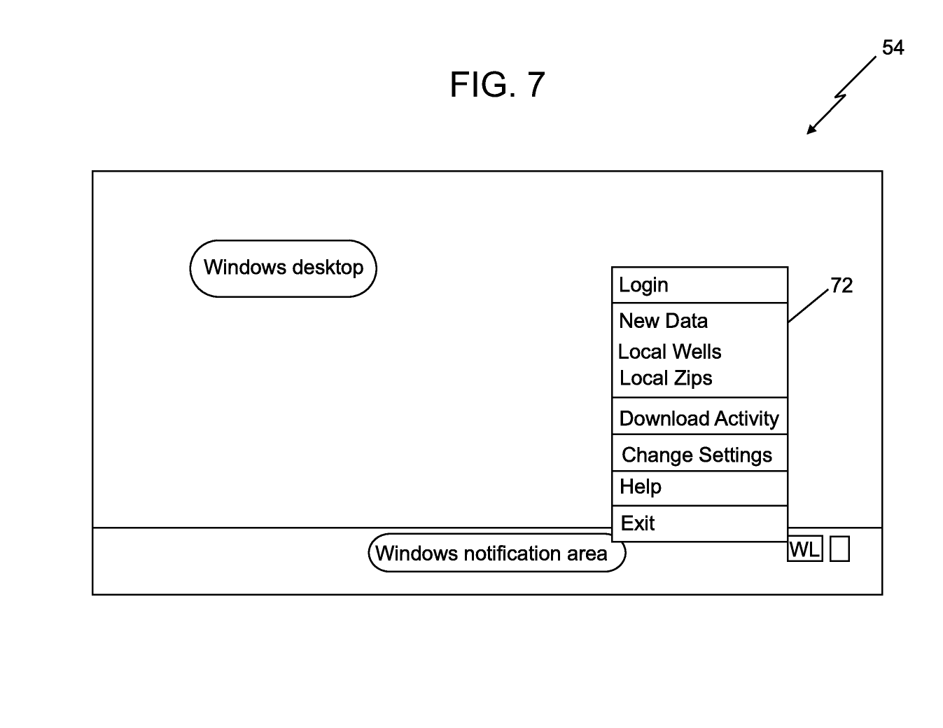

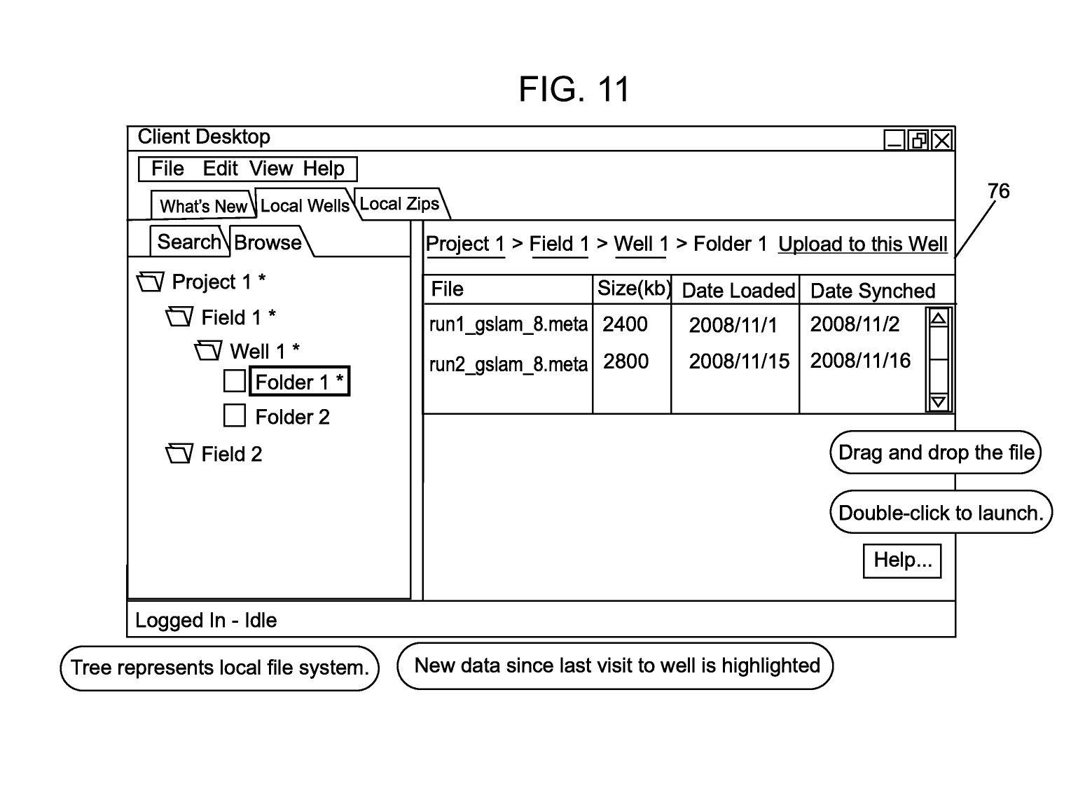

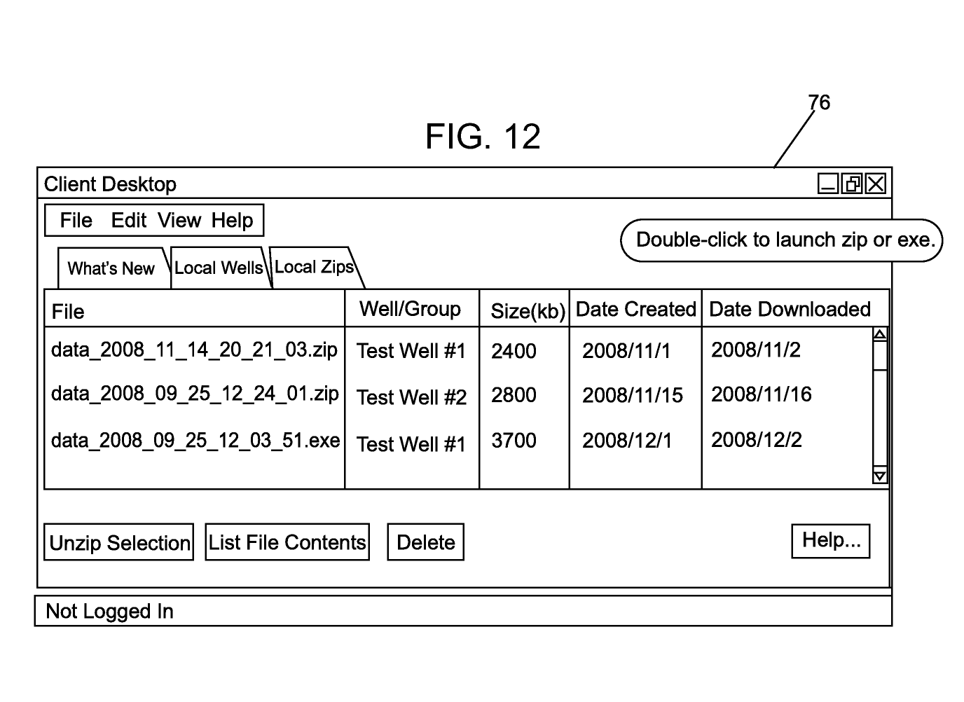

Referring to FIGS. 7-14, an example of an interface 54 utilized by a user is shown. In this example, the interface is a Microsoft Windows PC display. As demonstrated, the user does not actively engage the client system 34 application, as communication and data transfer are automatically achieved. The application generally remains low-key while dormant as a background process as an icon in the Windows Notification Area, as shown in FIG. 7.

In one embodiment, the WL icon changes appearance based on the application's status. For example, the icon background changes correlates with the status as follows:

| Status | Background Color |
|---|---|
| Disconnected | Grey |
| Online | White |
| Logged-In | |
| Downloading | Orange - Lightning Icon |
| New Data Available | Orange - Red Outline |

In one embodiment, hovering a mouse pointer over the icon displays its status as a tooltip in the format “<name> <status>.”

| Status | Mouse-over Tooltip |
|---|---|
| Disconnected | Offline |
| Online | Not Logged-In - Online |
| Not Logged-In | |
| Online | User Name - Online |
| Logged-In | |
| Downloading | User Name - Downloading |
| New Data Available | User Name - New Data |

Clicking the icon displays, for example, a menu 72. Examples of menu items or options include “Login”, “New Data”, “Local Wells”, “Local Zips”, “Download Activity”, “View Downloads”, “Browse Database”, “Change Settings”, “ Web Site”, “Help”, “About ” and “Exit”.

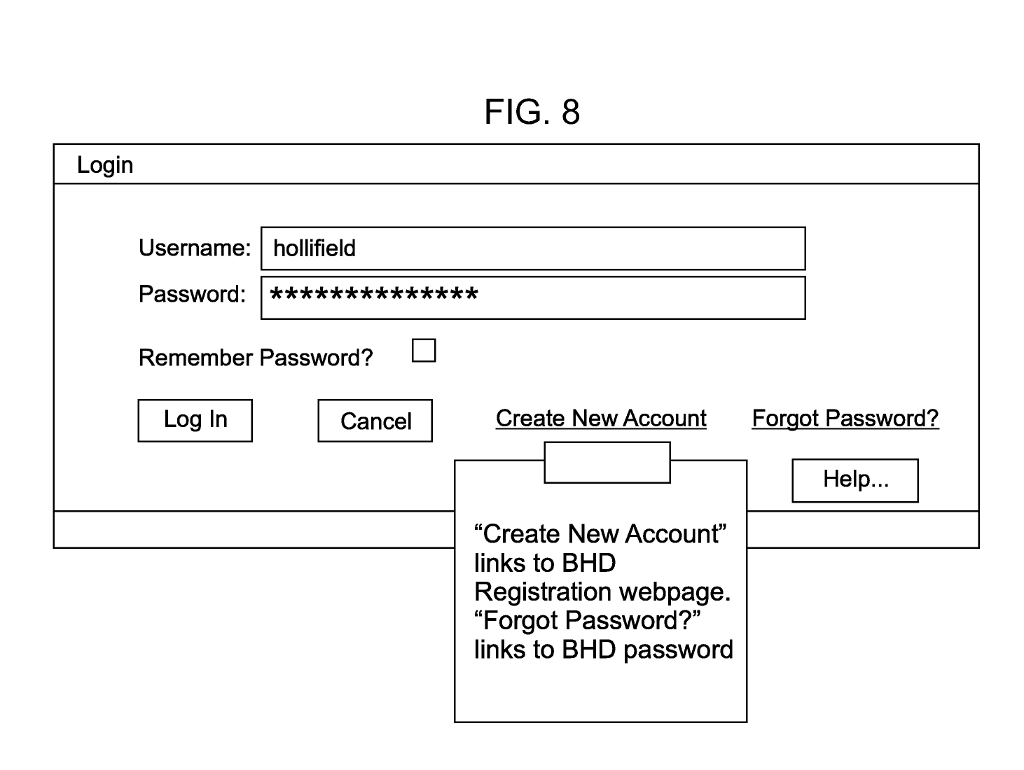

Referring to FIG. 8, a “Login” dialog box 74, which opens in response to choosing the Login option in the menu 72 includes fields for a username and password, an option to remember the password (i.e., use the password for all future logins). The create new account option allows the user to link to a selected web page associated with the host system 32.

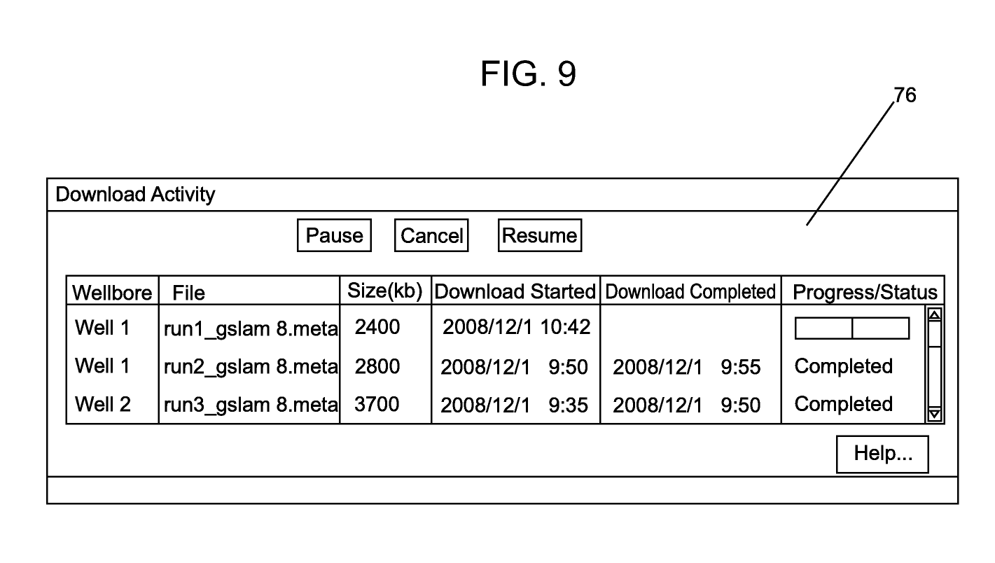

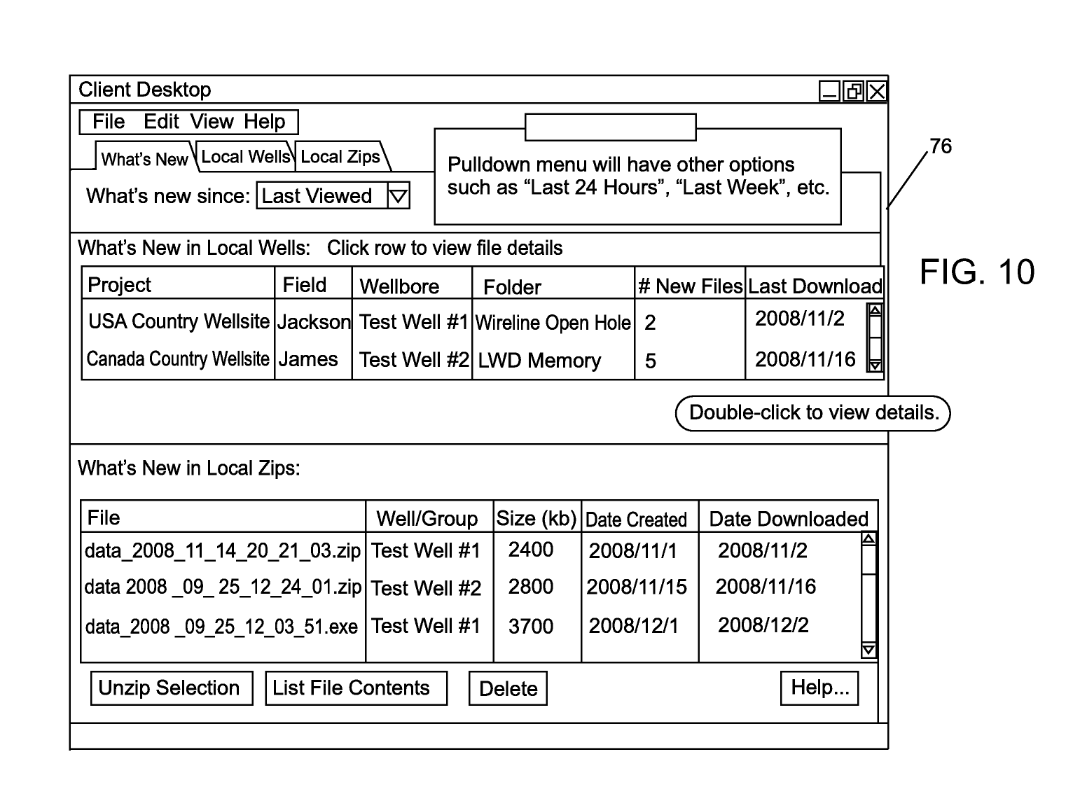

Referring to FIG. 9, a “View Downloads” or “Download Activity” dialog box 76 includes a scrollable list of prior and in-progress downloads. The list may be in chronological order with the newest first. In-progress downloads may be shown first. Examples of metadata fields for each requested file include the download date, the wellbore name, the operator, the file size, and the percent downloaded or download progress. FIGS. 10-12 illustrate embodiments of the Download Activity dialog box that include additional menus and fields allowing a user to view downloads relating to specific fields, wells and zip data, shown as “Local Wells” and “Local Zips”.

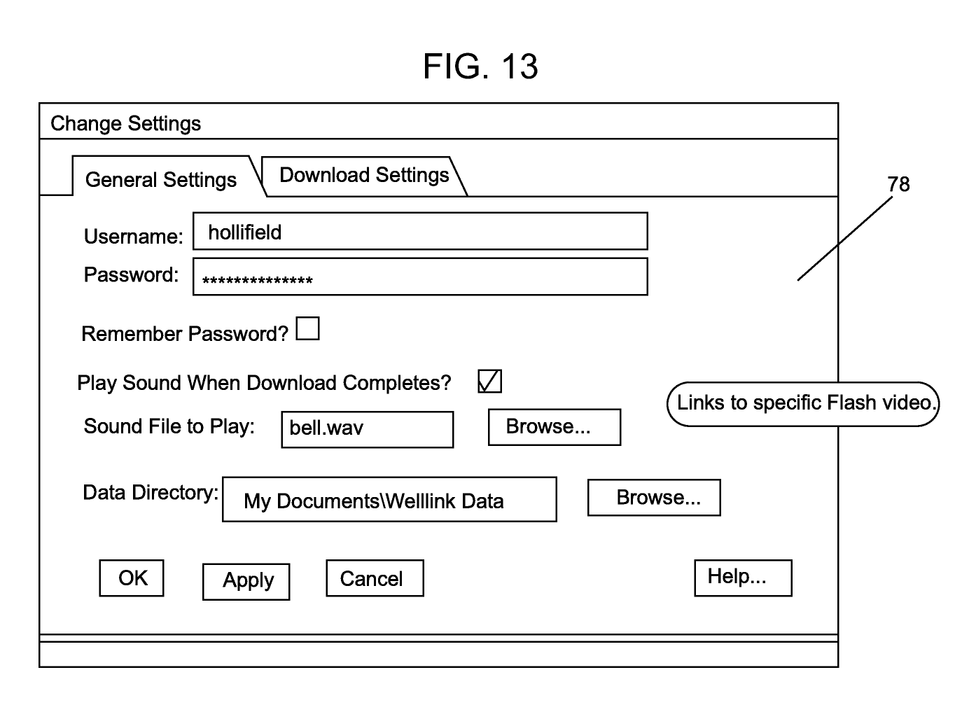

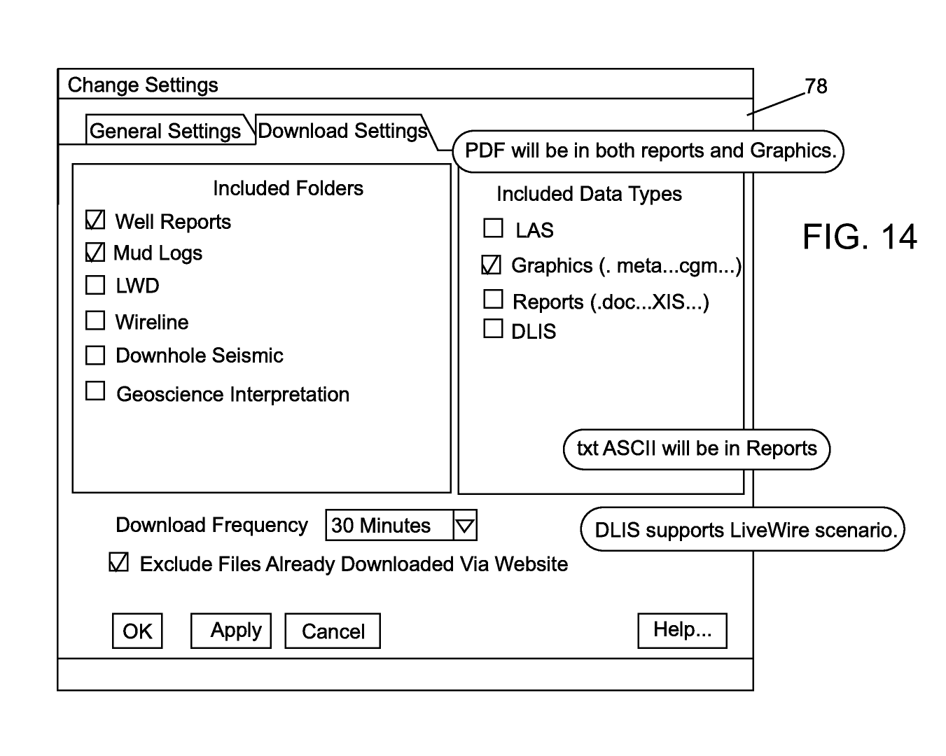

Referring to FIGS. 13-14, a “Change Settings” window or dialog box allows a user to change various aspects of the application, including General Settings; such as username and password, whether to automatically open files (e.g., as textbox; default .meta, .cgm, .tif, .pdf), whether to play a sound when a download completes (Browse button to select WAV file), and the local directory where data is saved; and Download settings, such as whether to include various types of reports and various data types may also be changed.

In one embodiment, when a new download starts, the user may elect to be notified. When a download ends, the user may again be notified. In both cases, a chime may also sound. These notifications may be small windows that appear above the Notification Area. They may also contain the following information: Wellbore Name, Uploader Comment, and filenames of Enclosed Data, for example.

Additional features of the interface 54 and the client system 34 include a “Setup Wizard” and an “Advanced Options” window or dialog box. The Setup Wizard allows a user to set authentication credentials, set application program and/or database options, set network options (e.g., Port, Proxy, Frequency of Updates), and set feedback options (e.g., Audio Clips Y/N, Notification Level).

Examples of Advanced Options include:

### 1. Personal Options

Save/Change Username & Password

Set/Change Local Database Directory

Change Well Data Notification Preferences

### 2. Corporate Options

Customer DB Integration Options

Email Options (SMTP Hostname and Credentials for Internal Notifications)

Report Options (Usernames to Receive Periodic Admin Reports)

### 3. Notification Level Setting

Each notification type may be turned on or off in Settings. Examples of notification types include:

Server Sync
Sync Success—No notification
Sync Failure—Notify
   List changed options
      Allow user to browse data and change local settings.
      User cannot receive new data or notifications.
   Retry in 5, 10, 30 minutes, 1 hour, 1 day, etc.
   On-click, Open Diagnostics Window

Data Receipt
Download Started—Notify
   Show Data Info
      Operating Company
      Wellbore Name
      Comment from Uploader
      Filenames of the Enclosed Data
      Data Size
   On-click, open Download Progress Window
Download Finished—Notify
   Show Data Info (as when Download Started)

The following examples illustrate exemplary options offered to the user via the interface 54 for various operating situations.

In a first example (i.e. “Example 1”), the host system 32 and/or associated networks are disconnected from the client system 34. In this example, all online services are disabled and only local client system services functions are available. Options (accessible for example by left or right-click) include:

### Browse Local Database

Review/Open Past Events

Change Settings

View About Box>Diagnostics>Save Troubleshooting Report as File

Shut Down Application.

In a second example (i.e., “Example 2”), the client system 34 is connected to the host system 32 but the user is not authenticated. In this example, the client system 34 can communicate with the database subsystem 36, such as the server, but lack of authentication prevents action specific to any particular user. Left-click and Right-click Options include:

Hyperlink to Account Registration Web Page

About . . . >Diagnostics . . . > Send Troubleshooting Report w/Comment

All Example 1 Options

In a third example (i.e., “Example 3”), the client system 34 is not connected to the host system 32, but the user is authenticated. This situation may occur when the user has been authenticated and the connection subsequently is dropped or lost. Left-click and Right-click Options include all Example 1 Options.

In a fourth example (i.e., “Example 4”), the client system 34 is connected to the host system and the user is authenticated. In this example, the client system application is in normal standby mode and all features are available. Left-click and Right-click Options include:

Upload Data (Wizard)

Shortcut to WL Web Site

All Example 1 Options

In a fifth example (i.e., “Example 5”), an event occurs in the form of new well data received by the client system 34. A notification is displayed, and details are displayed upon clicking the notification window or upon clicking the event in an event log. Left-click and Right-click Options include:

Notification Area Pop-up Dialog
Well Alias
Uploader Comment
Filenames of Enclosed Data
Click to view well's data sorted in reverse time
Logo in background
Chime/Announcement Sound

All Example 4 Options

In a sixth example (i.e. “Example 6”), an event occurs in the form of an announcement received in the client system 34 from the host system 32. A notification is displayed, and details are displayed upon clicking the notification window or upon clicking the event in an event log. Left-click and Right-click Options include:

Notification Area Pop-up Dialog
Display Announcement Picture
Click to View Announcement Web Page
Chime/Announcement Sound

All Example 4 Options

The CDA or other client system software may also interface with one or more third party databases to supplement or replace the local database 48 included with the CDA. In addition to well data, accompanying metadata or file attributes may be stored in this way. These third party databases may be located, for example, on the client system 34 such as the user's personal computer or on a network. The third party database interface may be configured to automate transfer of well data directly into other computer systems.

The CDA may also include user-programmable scripting capability, allowing the user to automatically print, email, convert, and/or otherwise process received well data using the user's proprietary tools and workflows.

One or more aspects of the present invention can be included in an article of manufacture (e.g., one or more computer program products) having, for instance, computer usable media. The media has therein, for instance, computer readable instructions, program code means or logic (e.g., code, commands, etc.) to provide and facilitate the capabilities of the present invention. The article of manufacture can be included as a part of a computer system or provided separately. These instructions may provide for equipment operation, control, data collection and analysis and other functions deemed relevant by a system designer, owner, user or other such personnel, in addition to the functions described in this disclosure.

One example of an article of manufacture or a computer program product for executing the methods described herein is described with reference to FIG. 15. A computer program product 80 includes, for instance, one or more computer usable media 82 to store computer readable program code means or logic 84 thereon to provide and facilitate one or more aspects of the methods and systems described herein. The medium can be an electronic, magnetic, optical, electromagnetic, infrared or semiconductor system (or apparatus or device) or a propagation medium. Example of a computer readable medium include a semiconductor or solid state memory, magnetic tape, a removable computer diskette, a random access memory (RAM), a read-only memory (ROM), a rigid magnetic disk and an optical disk. Examples of optical disks include compact disk-read only memory (CD-ROM), compact disk-read/write (CD-R/W) and DVD.

The methods and systems described herein provide various advantages over prior art techniques. The methods and systems described herein provide an application such as a PC application that does not require a user to actively request new well data, and that application facilitates intuitive and quick interaction between well data databases and users. The methods and systems described herein may integrate secure transmission of data across computer networks. The methods and systems described herein may also integrate automatically organized data storage. The methods and systems herein are not affected by problems associated with traditional email-based and web-based third-party clients.

In support of the teachings herein, various analyses and/or analytical components may be used, including digital and/or analog systems. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

1. A method of delivering well data, the method comprising:
monitoring a host well data system by a client computer, the host well data system including at least one storage component configured to store well data therein; and
determining, without requiring user interaction, whether the well data includes new well data including data that has not been previously delivered to a user.

2. The method of claim 1, further comprising sending, without requiring user interaction, a message from the client computer to the host well data system, the message including a request for the new well data.

3. The method of claim 1, further comprising receiving the new well data by the client computer from the host well data system.

4. The method of claim 1, wherein monitoring is selected from continuous monitoring and periodic monitoring.

5. The method of claim 1, wherein at least one storage component is a well data database.

6. The method of claim 1, wherein determining, without requiring user interaction, whether the well data includes the new well data includes identifying a subset of the well data that conforms to at least one type of data that the user has selected for delivery.

7. The method of claim 1, wherein determining whether the well data includes the new well data includes identifying a subset of the well data that the user is entitled to receive.

8. The method of claim 2, wherein the message includes a user identifier and authentication information.

9. The method of claim 1, further comprising notifying the user upon receipt of the new well data.

10. The method of claim 1, wherein the client computer includes a display.

11. The method of claim 1, wherein notifying the user is selected from at least one of generating an audible signal and generating a visual indication of the receipt of the new well data.

12. The method of claim 1, further comprising receiving log-in information from the user by the client computer.

13. The method of claim 12, wherein the log-in information includes at least one of a user identifier, a password and a well data type preference.

14. A method of delivering well data, the method comprising:
monitoring a host well data system by a client computer, the host well data system including at least one storage component configured to store well data therein;
determining, without requiring user interaction, whether the well data includes new well data including data that has not been previously delivered to a user;
receiving, without requiring user interaction, at least one subset of the new well data, the subset including data conforming to at least one type of data that the user has previously selected for delivery; and
delivering the at least one subset of the new well data.

15. The method of claim 14, wherein receiving at least one subset of the new well data includes sending a message, which includes a request for the new well data, from the client computer to the host well data system.

16. The method of claim 14, wherein the subset includes data that the user is entitled to receive.

17. The method of claim 14, further comprising notifying the user upon receipt of the new well data.

18. A computer program product including machine-readable instructions stored on machine readable media, the instructions for delivering well data by implementing a method comprising:
monitoring a host well data system by a client computer, the host well data system including at least one storage component configured to store well data therein; and
determining, without requiring user interaction, whether the well data includes new well data including data that has not been previously delivered to a user.

19. The computer program product of claim 18, wherein the method further comprises, without requiring user interaction, sending a message, which includes a request for the new well data, from the client computer to the host well data system.

20. The computer program product of claim 18, wherein the method further comprises receiving, without requiring user interaction, the new well data by the client computer from the host well data system.

21. The computer program product of claim 18, wherein monitoring is selected from continuous monitoring and periodic monitoring.

22. The computer program product of claim 18, wherein the at least one storage component is a well data database.

23. The computer program product of claim 18, wherein determining, without requiring user interaction, whether the new well data includes a subset of the well data that conforms to at least one type of data that the user has previously selected for delivery.

24. The computer program product of claim 18, wherein determining, without requiring user interaction, whether the new well data includes a subset of the well data that the user is entitled to receive.

25. The computer program product of claim 18, wherein the message includes a user identifier and authentication information.

26. The computer program product of claim 18, wherein the method further comprises notifying the user upon receipt of the new well data.

27. The computer program product of claim 18, wherein notifying the user is selected from at least one of generating an audible signal and generating a visual indication of the receipt of the new well data.

28. A system for delivering well data, the system comprising:
a host well data system including at least one storage component configured to store well data therein;
a client computer communicatively coupled to the host well data system, the client computer performing:
monitoring the host well data system without requiring user interaction; and
determining, without requiring user interaction, whether the well data includes new well data and whether the new well data includes data that has not been previously delivered to a user.

29. The system of claim 28, wherein the client computer further performs, without requiring user interaction: sending a message requesting new well data from the client computer to the host well data system and receiving the new well data by the client computer from the host well data system.

30. The system of claim 28, wherein determining, without requiring user interaction, whether the new well data includes a subset of the well data that conforms to at least one type of data that the user has previously selected for delivery.

31. The system of claim 28, wherein determining, without requiring user interaction, whether the new well data includes a subset of the well data that the user is entitled to receive.

32. The system of claim 28, wherein the client computer further performs notifying the user upon receipt of the new well data.

33. The system of claim 28, wherein notifying the user is selected from at least one of generating an audible signal and generating a visual indication of the receipt of the new well data.
